(19) United States
(12) Patent Application Publication
(10) Pub. No.: US 2004/0216135 A1
(43) Pub. Date: Oct. 28, 2004

(54) Selective user input notification for multiple applications

(76) Inventor: Reid D. Heimbeck, Bellevue, WA (US)

Correspondence Address: Kieun Jenny Sung, Gray Cary Ware & Freidenrich, 1755 Embarcadero Road, Palo Alto, CA, 94303, US

(21) Appl. No.: 10/422,405

(22) Filed: Apr. 23, 2003

(51) Int. Cl. G06F 9/00

(52) U.S. Cl. 719/318; 719/321

(57) ABSTRACT

The invention pertains to a method and device for sending an event from a device driver to multiple running applications. When used in conjunction with an operating system that has a broadcasting function, the method entails using the message broadcasting function that is native to the operating system (e.g., Windows CE) to channel an event (e.g., a user input) from the device driver level directly to multiple active applications. Upon creating the event to be broadcast, a data table that includes search values and broadcast data values may be used to translate the event into a broadcast value that is understood by the applications. The message to be broadcast may include an identifier that indicates to the application how the message should be processed. Optionally, the data table may include a filter value indicating whether each event should be forwarded to the operating system.

### BACKGROUND

Today's standard Windows operating system allows a user to have multiple applications running at the same time so that the user can switch between applications easily without going through an application loading process each time. If multiple applications are running under the Windows operating system at the same time, only one application can have the user input focus at any given time. Thus, when a user inputs data into the system (e.g., from a keyboard, a mouse, or a remote control), only the application with the input focus receives that input data.

While this single-input-focus method works sufficiently well in many situations, there are situations where it would be advantageous for all the running applications to receive the input. For example, if a Windows CE based computer were utilized for any kind of system control, there would most likely be at least one running application that always monitors for certain user inputs in order to effectively process the control mechanism. To enable the control application to always respond to user inputs, the system can be designed in one of two ways: 1) the system could be designed to prohibit any other application from taking the user input focus, or 2) the system would have to guarantee that the control application always receives user inputs regardless of which application has the user input focus. The first option is undesirable because it negates many of the multitasking benefits of the system.

Some Windows operating systems (e.g., Windows NT, Windows 2000, Windows XP) implement the second option by providing a standard Win32 library function that can be utilized by any running application to receive user input data regardless of the input focus. These standard Win32 library functions are commonly referred to as “hooks.” A “hook” is a mechanism by which a function (herein referred to as a “filter function”) can intercept events (e.g., messages, mouse actions, keystrokes) before the events reach an application. For Windows to call a filter function, the filter function must be attached to a Windows hook. When a hook has more than one filter function attached and the hook is triggered, Windows calls the first filter function in the chain of filter functions. Once an event or a message is intercepted, the filter functions can modify or otherwise process it. Because filter functions are called by Windows and not by an application, they are sometimes referred to as “callback functions.”

The hook mechanism is not available in all operating systems. For example, Windows CE does not include the hook mechanism. Furthermore, the hook mechanism lacks reliability. After Windows calls the first function in the hook's filter function chain, the called filter function (and not Windows) is responsible for ensuring that the next filter function in the chain is called. At times, a filter function may not pass an event to the other functions on the chain. For example, when a filter function modifies a message, it may decide not to pass the message to the rest of the filter function chain. Since filter functions are not installed in any particular order, it is difficult, if not impossible, to predict where the event is in the chain of filter functions. Thus, the hook mechanism does not reliably deliver an event to all the intended recipients.

There is a need for a method of reliably delivering an event to all the intended recipients regardless of which recipient has the input focus.

### SUMMARY

The invention pertains to a method and device for sending an event from a device driver to multiple running applications. When used in conjunction with an operating system that has a broadcasting function, the method entails using the message broadcasting function that is native to the operating system (e.g., Windows CE) to channel an event (e.g., a user input) from the device driver level directly to multiple active applications. Upon creating the event to be broadcast, a data table that includes search values and broadcast data values may be used to translate the event into a broadcast value that is understood by the applications. The message to be broadcast may include an identifier that indicates to the application how the message should be processed. Optionally, the data table may include a filter value indicating whether each event should be forwarded to the operating system.

### BRIEF DESCRIPTION OF THE DRAWINGS

FIG. 1 is a schematic diagram of a computer system including user input devices that may be used to implement the invention;

FIG. 2 is a schematic diagram of a hardware system including application software that may be used to implement the invention;

FIG. 3 is a flowchart of a data fowarding process in accordance with the invention, from the perspective of a device driver software; and

FIG. 4 is a flowchart of the data forwarding process in accordance with the invention, from the perspective of an application software.

### DETAILED DESCRIPTION OF THE PREFERRED EMBODIMENT

The invention pertains to a method and system for forwarding an event to multiple software applications regardless of input focus. Although the invention is described in the context of a Windows CE operating system, it will be appreciated that the invention may be used in any system that could benefit from multiple software applications receiving an event.

A “running application” or an “active application,” as used herein, refers to a software application that has been loaded and does not indicate whether the application has input focus. An application that has “input focus” would be the one application out of all the running applications that receives an event in the current Windows CE operating system without the invention. An “event,” is any information that can be forwarded to one or more of the applications, such as a user input.

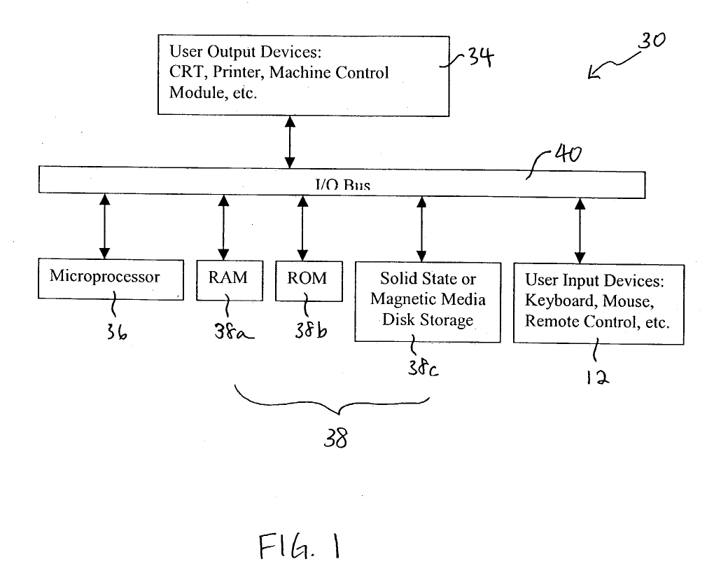

FIG. 1 is a block diagram of the components that form a computer system 30 that can support an operating system (e.g., Windows CE) and a user input device. The computer system 30 includes at least one user input device 12, at least one user output device 34, a microprocessor 36, and various storage means 38 such as a RAM 38a, a ROM 38b, and a solid state storage device 38c. These components are connected to a bus 40, which allows data exchange between the components. The user input device 12 may be any conventional device that is used to feed information to a computer, such as a keyboard, a mouse, an infrared remote control, and a microphone. The user output device 34 may be any means by which a user would receive information from the computer, such as a monitor (CRT, LCD, etc.), a printer, a speaker, and a machine control module. The components shown in FIG. 1 are well-known parts that a person of ordinary skill in the art would know how to obtain.

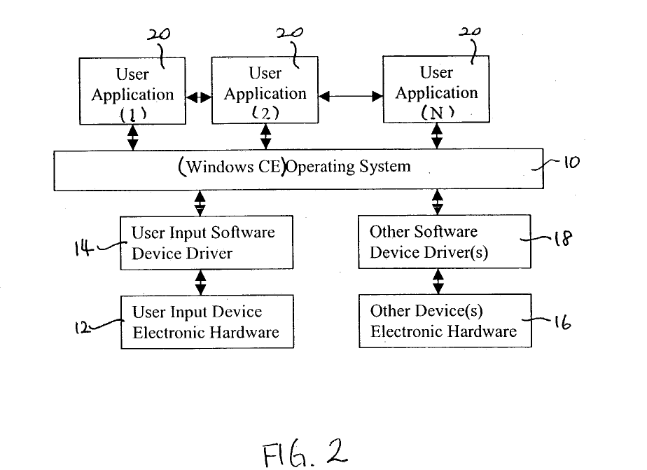

FIG. 2 shows a conceptual hierarchy of the layers between hardware devices (e.g., a user input device) and user applications. A hardware device is connected to an operating system 10 through a software device driver. For example, a user input device 12 communicates with the operating system 10 through a user input software device driver 14, and any other device 16 communicates with the operating system 10 through its own device driver 18. An active user application 20, such as any one of user applications 20(1), 20(2) . . . 20(N), exchanges information with the device driver software 14, 18 through the operating system 10.

Typically, an operating system implements device drivers to allow hardware-specific operations to be separated from general system management issues. The Windows CE operating system, for example, allows several driver layers (including an intermediate driver layer and a hardware driver layer) to exist between an application program and a device. These intermediate drivers are generally referred to as a “class driver,” while the hardware driver is generally referred to as a “port driver.” Each user input device 12 has a device driver 14. For example, a keyboard has a “keyboard driver” and a mouse has a “mouse driver.” The invention may be used to modify a user input device driver and, more specifically, an input device port driver that acts as the low level interface between the operating system and the device hardware (e.g. the Windows CE keyboard port driver).

The invention may preferably use a standard feature of the Windows CE operating system (in a Windows CE embodiment of the invention) called message passing. With a data event message passing system, the Windows operating system routinely sends event messages to all running applications. Further, any application can send a message to one or more of the other running applications by using the same message passing system. Message passing is typically used between the operating system 10 and the user applications 20 or between the different applications 20, but not between the device driver 14, 18 and the user application 20. The invention uniquely uses the message passing feature to control the communication between device drivers 14, 18 and user applications 20.

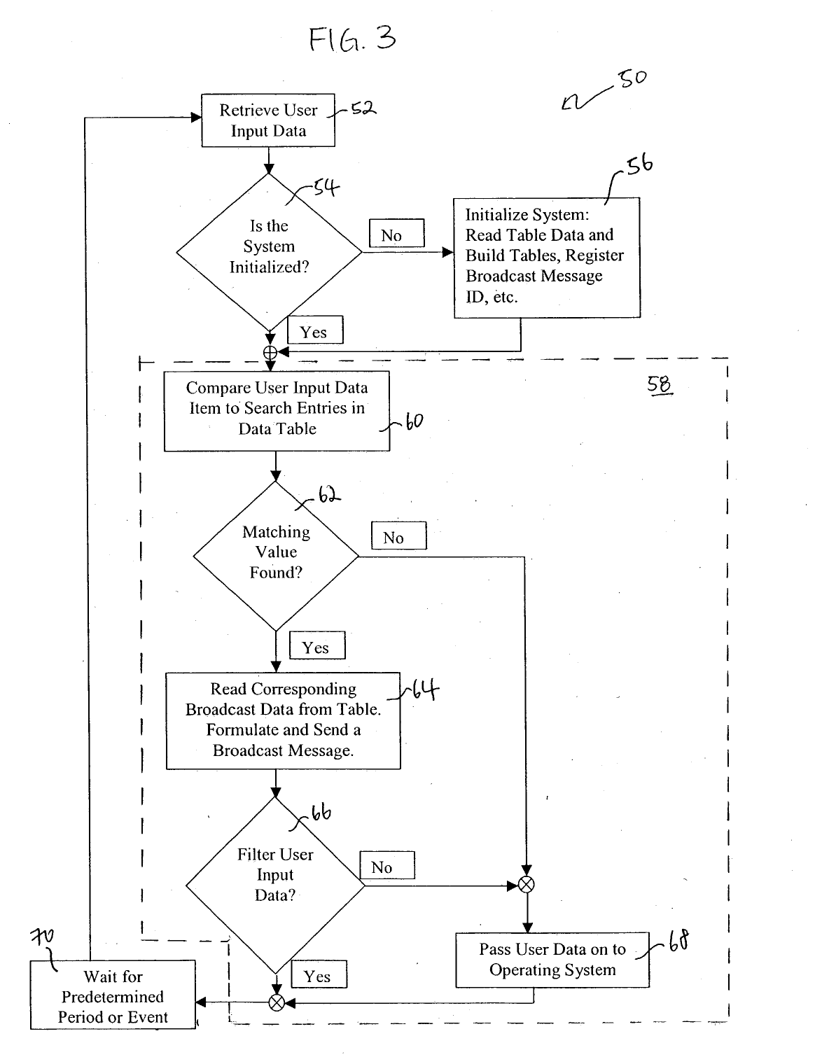

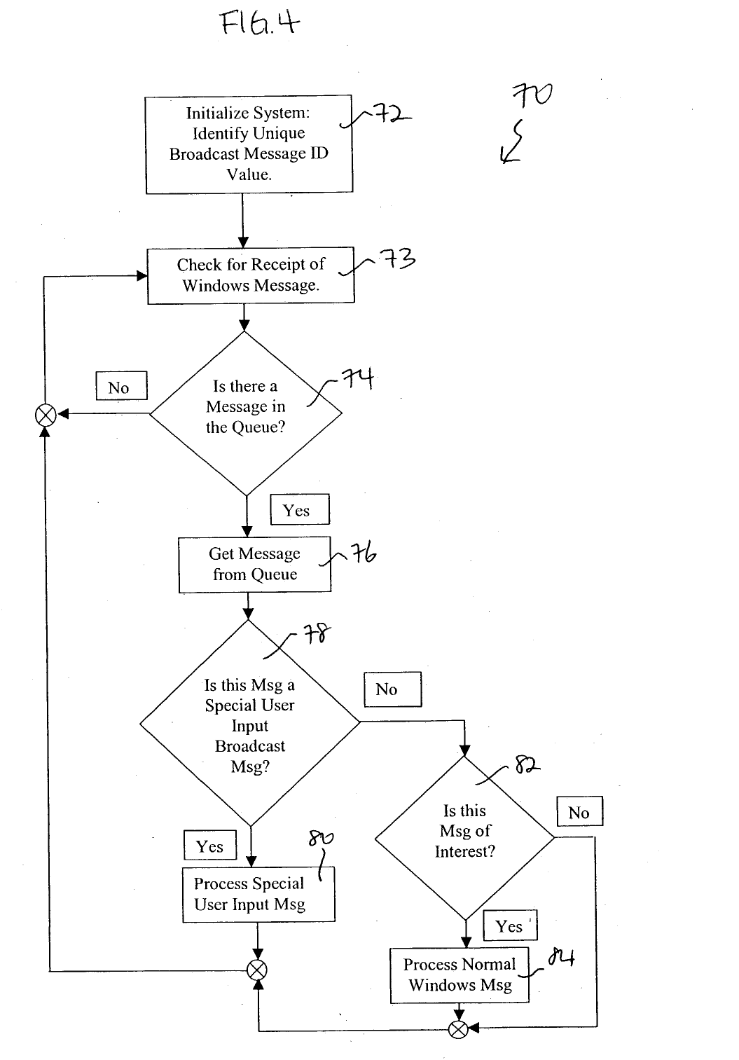

This invention requires the insertion of a software code section inside the standard user input driver code to modify the standard driver process. The novel code section includes a data forwarding process 50 (shown in more detail in FIG. 3) that pertains to the device driver and, in one aspect, also a data receiving process 70 (shown in FIG. 4) that pertains to the user application. The new software code, which contains a software call to a standard Windows CE API function “PostMessage,” is inserted in the driver code at a point just after the driver has retrieved the user input data but before the retrieved data is forwarded to the operating system. The effect of this newly inserted call to “PostMessage” is to broadcast a message to all running applications upon receipt of user input data. Thus, the inserted code allows the operating system to simultaneously send user input data to multiple running applications.

FIG. 3 is a flowchart illustrating the data forwarding process 50 that is performed by a device driver software in accordance with the invention. The data forwarding process 50 is triggered by an event, which is usually the detection of a newly received user input data (stage 52). When new user input data is detected, the device driver checks to see if the driver is initialized (stage 54). If the driver has not been initialized yet, the driver software waits for the initialization to complete (stage 56). Driver initialization may include retrieving data from a nonvolatile source such a file, a registry, a hard-coded data table, etc. that may be stored in the ROM 38b (see FIG. 1). During initialization, using the retrieved data, the driver builds one or more data tables. The data table includes a set of possible inputs (e.g., keyboard scan codes) and maps values and/or instructions corresponding to each of the possible inputs. An exemplary data table looks like:

TABLE 1

| search value | broadcast data value | filter flag value |
|---|---|---|
| E010 | 10 | 1 |
| E005 | 05 | 1 |
| E016 | 16 | 1 |
| E02C | 2C | 0 |
| E004 | 04 | 0 |
| E068 | 68 | 1 |

wherein the column labeled “search value” corresponds to different user inputs. As can be seen, each search value has a corresponding broadcast data value, which is a unique message that is broadcast if a user input matches one of the search values. In addition to building the data table, driver initialization includes other functions, such as registration of Broadcast Message ID.

The initialization process, which is well known, can only be completed after the Win32 Library has been completely initialized. In accordance with the invention, the operating system waits until the first user input is received to generate a system broadcast message corresponding to the user input, and waiting for the first user input ensures that the Win32 Library initialization has been completed. A special aspect of using the “RegisterWindowMessage” API method from within a Windows software driver is in having to delay the call to this API method until the whole operating system has fully initialized after start-up or reboot. Normally, the operating system calls each driver initialization method early on in the operating system initialization process because this would be the logical time for the customized driver to call “RegisterWindowMessage” and configure all of its operational parameters necessary to perform the message broadcasts. However, at driver initialization time, the operating system subsystem containing support for “RegisterWindowMessage” is not yet available, as it has not yet been initialized. Therefore, in order to reserve a unique Windows message identifier, the call to “RegisterWindowMessage” must be delayed until this service is available.

In one embodiment, this delay in calling “RegisterWindowMessage” is arranged by waiting for the receipt of the first user data input, which does not happen until the system has fully initialized. The “RegisterWindowMessage” API needs to be called just once in the driver and application programs. Therefore, in the driver, the call to “RegisterWindowMessage” happens on the receipt of user input data, but is always first qualified by an initialization flag variable so that it happens only once per instance of the driver.

Every Windows message must have an identifier so that the recipient application can effectively determine how or if to act on a certain message data. Typically, the message identifying parameter is selected from a predetermined list provided by the Windows operating system. An arbitrary message ID value out of the range of the standard set of message ID values may be used as the identifier by the Windows operating system. However, this value would not be a guaranteed safe means for choosing a unique message ID because the same message ID could be chosen for a different purpose by another process in the system, creating a conflict. The arbitrarily chosen identifier will work only as long as no other process in the system chooses this message ID value for another purpose.

Preferably, a unique identifier is reserved through the “RegisterWindowMessage” standard API method that are provided by most Windows operating systems. A new system-wide unique message identifier to use with the broadcast technique is defined so that the recipient applications will recognize these special messages as being different from other messages that are directed only to the application with the input focus. The “RegisterWindowsMessage” API method takes an input text string and returns a unique identifier value. The first application calling “RegisterWindowMessage” with a given input text string parameter receives a new and unique message identifier value. Once the first call is made, all subsequent calls to “RegisterWindowMessage” with the same input text string parameter is assigned the same message identifier value. This way, all components in this broadcast message passing system to agree on using the same, unique message identifier. All components in this system must have process by which to know or find the message identifying input text string used when calling “RegisterWindowMessage.” As a person of ordinary skill in the art will understand, other ways of making the components in the broadcast message passing system use the same message identifier may be used without departing from the spirit of the invention.

Once initialization is complete, a search-and-compare routine 58 begins, whereby each event (e.g., user input data item) is compared to a search value in the data table Table 1 (stage 60). In particular, the search-and-compare routine 58 would go down the column labeled “search value” in Table 1 looking for a matching value (stage 62). If a matching search value is identified, the process uses the broadcast data value that corresponds to the matching search value as a third data parameter (see below) in the call to “PostMessage,” which broadcasts the event to all running applications (stage 64). The Windows API method “PostMessage” takes four input parameters, which may be:

1. The “HWND_BROADCAST” macro used to indicate that the message is to be broadcast,

2. The unique message identifier returned by the call to “RegisterWindowMessage,”

3. “wParam”: carries user defined data, and

4. “lparam”: also carries user defined data.

The last two parameters are generic 32-bit integer data values used to describe message specific information. The broadcast message design uses the “wParam” (third) parameter to indicate the user input data, and the “lparam” (fourth) parameter to indicate the state of the user input data action: first occurrence, repeat occurrence, or last occurrence of the user input. For example, this corresponds to a keyboard key being first pressed, held down, or finally being released.

After sending a broadcast message, the device driver checks the filter flag value in Table 1 (stage 66) to see if it should pass the event (e.g., user data input value) on to the Windows operating system. If the filter flag value so indicates (“1”), the retrieved user data is passed on to the operating system (stage 68). After the proper action has been taken according to the filter flag value, the driver waits for a predetermined period or an event (stage 70) before re-performing the data forwarding process 50.

To summarize the data forwarding process 50, the device driver simultaneously notifies multiple running applications of certain events by using its ability to broadcast messages. Broadcasting a Windows message is done through the same standard API call “PostMessage” that is used to send a message to one specific recipient. With Broadcasting, the first parameter in the call to “PostMessage” is the special macro “HWND_BROADCAST” instead of a Window Handle to a single recipient application. Calling “PostMessage” with the “HWND_BROADCAST” macro parameter instructs the Windows operating system to place the message data into the message queue of every application that is currently running on the system.

FIG. 4 is a flowchart of the data receiving process 70 that is performed by code embedded in an application software. The data receiving process 70 is part of the software modifications that would be done to a high-level application in order to receive and process messages from the modified user input device driver. Messages sent to an application are placed in a message queue by the Windows operating system. Each running application has its own message queue, which the application periodically polls to check for the presence of new messages. When the application retrieves a message from its message queue, it determines what type of message it is, and determines if it needs to act on this event. The application receives normal user input events through this message system.

Upon initialization, the application software identifies a unique Broadcast Message ID value (stage 72) in the received message. The Broadcast Message ID value is later used by the application to determine whether a message is a special broadcast message so that if it is a broadcast message, it can be processed properly. The application software then checks the queue to see if there is a message (stages 73 and 74). If there is a message, the message is retrieved (stage 76) and checked for an indication that this is a special user input broadcast message (stage 78).

In order for a user application to recognize the special broadcast user input data in stage 78, there is a code section inside the application's message handling code block that allows it to recognize the unique identifier associated with the special broadcast messages. To get this message identifier, a user application can call the “RegisterWindowMessage” API method just as the device driver did when it first created the unique identifier. Therefore, the application must have access to the same unique message string used by the device driver code. In a preferred embodiment, this unique Window Message string can easily be shared between source code in the driver and an application through the use of a common header file. For any running application inside the Windows operating system to receive user input event notification, it needs to have a standard Windows message handling code block implementing a system-wide identifier. For outside applications to “learn” this identifier code, they must retrieve from the common source code header file the unique “WM_MESSAGE” name string used by the system for tagging an event (e.g., user input data).

If a message includes the unique identifier for the special broadcast message, the message is processed as a special user input message (stage 80). On the other hand, if the message does not include the unique identifier, the application checks to see if this is a message of interest (stage 82) and processes the message as a normal Windows message (stage 84) only if it is of interest. A person of ordinary skill in the art will understand that the method of determining whether a message is of interest varies from application to application. Generally, each application maintains a list of messages that are “of interest” to it. The code for each application has some form of a message-handling table or list containing entries for all messages it is to process. If the message is not of interest (i.e., not on this table or list), it is ignored. After processing a message, the application loops back to stage 73 and checks if there is another message to process.

The invention provides a multiple-destination event forwarding function to operating systems that do not provide a means to override the input focus, such as the Windows CE operating system. Furthermore, the invention provides a more reliable event forwarding function than the hook mechanism that is included in operating systems like Windows NT and XP.

The invention differs from the conventional “hook” mechanism in a number of ways. For example, while the hook method provides event information only to applications that “hook” the input data, the method of the invention provides event information to all running applications. Thus, unlike the hook mechanism, which requires that the operating system maintain a list of applications that have hooks for a data source, the operating system need not maintain a recipient list. Furthermore, while the hook method may be preempted by another keyboard hook that is installed later in the chain, the broadcast method of the invention cannot be preempted. Thus, the broadcast method provides a more reliable delivery of the message. Also, while the hook method requires the hooking application to provide either a “callback” or the address of a filter function to be called by the operating system on receipt of input data, no such callback function is necessary for the broadcast method because the broadcast method relies on message processing routines of the recipients. Additionally, the broadcast method does not require any special processing by the operating system, unlike the hook method. In the hook method, the operating system has to call the hook function upon receiving new input. In contrast, the broadcast method creates an alternate data channel to the standard operating system data input mechanism. Moreover, the broadcast method provides more flexibility than the hook method. While the hook method can only be used for events from preselected sources (e.g., the keyboard, the mouse), the broadcast method, software drivers for non-standard hardware can utilize this technique to send event notification to applications. Thus, if there was a “stop” switch wired to a general purpose PC I/O card, events from this “stop” switch would not be hooked by the hook method. However, this “stop” switch can use the broadcast message technique to ensure event notification to all running applications.

The optional use of data table to translate an event into new values for broadcasting makes the invention highly adaptable to various systems. There are two main parts to the system of the invention: 1) a data broadcaster, and 2) multiple data recipients. Once all the recipient applications have been customized for this new method of receiving user input data event, it may become necessary to utilize a new user input device. This new user input device may not provide the same output data as the original device for a corresponding user action. Use of the data table translation ensures that a new mapping can easily be accomplished without modifying the data receiving applications.

A possible alternative to using a data table is a systematic translation of the event into some of the unique values that are used in the broadcast message call. This translation-based embodiment uses a numerical process instead of a table search. For example, the translation may entail operating on a user input data by multiplication, addition, etc. and using the resulting value as the parameter in the broadcast message call. In some embodiments, the input data values themselves may be used as the broadcast message parameters without any numerical operations.

The optional filtering of the input data is another benefit of utilizing a data table. Filtering data may be necessary to block certain input data values from reaching either the Windows operating system or any of the running applications, where it may cause undesirable results. The data table provides two layers of filtration. First, the table provides a selective list of data items containing the entire set of values to act upon. If a matching data value cannot be found in the table list, then the data item will not be acted upon. Second, if a matching item exists, the table can contain entries to indicate how it may be processed (e.g., whether it is passed on to the operating system). In an embodiment that does not include the filtering mechanism, the third column of Table 1 would be omitted.

The invention provides other advantages over the current system. By using a broadcast method to distribute important data, any “interested” application can listen for and receive the data without having to register with, or otherwise notify, the data source that it needs to receive the data. This relieves the programmer from having to implement extra code in both the application registering with the data server and for the data server maintaining a list of all those applications that have registered with it for event notification. Any application that is “not interested” in receiving the message can simply ignore it.

Furthermore, this technique can easily be customized to generate user input events on receipt of data from any user input device such as a remote control, keyboard, or a mouse by inserting the code section to the appropriate device driver.

The invention is also advantageous in that it is simple to implement in systems like Windows CE that already include a broadcast function. This ease of implementation stems from the fact that it relies on already-existing features of the operating system, such as broadcasting. Reliance on the already-existing features reassures that there will be no undesirable “side effects” affecting the performance of other system applications.

While the foregoing has been with reference to a particular embodiment of the invention, it will be appreciated by those skilled in the art that changes in this embodiment may be made without departing from the principles and spirit of the invention, the scope of which is defined by the appended claims.

What is claimed is:

1. A method of forwarding an event to multiple applications running on a computer system that includes a device driver interfacing with a device, the method comprising:
detecting an event at the device driver; and
broadcasting from the device driver data about the event to the multiple applications running on the computer system so each application receives the event data, wherein the event data includes a unique message identifier.

2. The method of claim 1, wherein the device driver interfaces between a user input device and Windows CE operating system.

3. The method of claim 1 wherein the device driver is an input device driver and the event is a user input received through an input device associated with the input device driver.

4. The method of claim 1 wherein device driver initialization further comprises building a data table, wherein the data table includes one or more search values and a broadcast data value for each search value.

5. The method of claim 4, wherein the initialization further comprises retrieving data from a nonvolatile storage to build the data table.

6. The method of claim 4 wherein the data table further comprises a filter value corresponding to each search value, the filter value indicating whether the event that matches a search value is forwarded to an operating system.

7. The method of claim 4, wherein broadcasting further comprises:
matching a search value in the data table with the detected event;
determining a broadcast data value that corresponds to the matched search value; and
broadcasting the broadcast data value.

8. The method of claim 7 further comprising blocking the broadcasting of the event if no search value matches the detected event.

9. The method of claim 1, wherein broadcasting further comprises calling a “PostMessage” routine and setting a first parameter of the “PostMessage” routine to HWND_BROADCAST.

10. The method of claim 1 further comprising adding an identifier to the event data indicating, to the application receiving the event data, information about whether and how to process the event upon receipt.

11. The method of claim 10 further comprising calling a “PostMessage” routine and inserting the event identifier into a second parameter of the “PostMessage” call.

12. The method of claim 1, wherein the initialization further comprises reserving a unique message identifier by calling “RegisterWindowMessage”.

13. The method of claim 12, wherein the reservation further comprises submitting a parameter to receive the unique message identifier, wherein the parameter is stored in a common header file that is accessible to the device driver and the applications.

14. The method of claim 12 wherein the unique message identifier indicates, to an application, that the event is different from a message that is directed to one specific application.

15. The method of claim 1 wherein device driver initialization further comprises performing a numerical operation on the event data to generate the unique message identifier.

16. An input device driver for a computer system having multiple applications, the device driver comprising:
computer instructions to detect an event; and
computer instructions to broadcast the event and a unique identifier indicating that the event is part of a broadcast message, wherein the broadcast message is sent from the device driver to multiple applications.

17. The input device driver of claim 16, wherein the device driver interfaces between a user input device and Windows CE operating system.

18. The input device driver of claim 16 wherein the event is a user input.

19. The input device driver of claim 16, wherein device driver initialization comprises building a data table, wherein the data table includes a set of search values and a broadcast data value for each of the search values.

20. The input device driver of claim 19, wherein the set of search values are retrieved from a nonvolatile storage.

21. The input device driver of claim 19 wherein the data table further comprises a filter value corresponding to each of the search values, the filter value indicating whether the event that matches each of the search values is meant to be delivered to an operating system.

22. The input device driver of claim 19 wherein the computer instructions for broadcasting comprise:
computer instructions to look for a search value that matches the detected event; and
computer instructions to determine a broadcast data value that corresponds to the search value based on the data table.

23. The input device driver of claim 22 further comprising computer instructions to refrain from broadcasting the event if there is no search value that matches the detected event.

24. The input device driver of claim 16, wherein the computer instructions for broadcasting comprise computer instructions to call “PostMessage” and set a first parameter of “PostMessage” to HWND_BROADCAST.

25. The input device driver of claim 16 further comprising computer instructions to add an identifier to the event indicating to a recipient application whether and how to process the event upon receipt.

26. The input device driver of claim 25 further comprising computer instructions to call “PostMessage” and make the identifier a second parameter of the “PostMessage” call.

27. The input device driver of claim 16 further comprising computer instructions to reserve a unique message identifier by calling “RegisterWindowMessage”.

28. The input device driver of claim 27 further comprising computer instructions to submit a parameter to receive the unique message identifier, wherein the parameter is stored in a common header file that is accessible to the device driver and the applications.

29. The input device driver of claim 27 wherein the unique message identifier indicates to the applications receiving the event that that the event is different from a message that is directed to one specific application.

30. The input device driver of claim 16 further comprising computer instructions to perform a numerical operation on the event data to generate the unique message identifier.
